(19) United States
(12) Patent Application Publication
(10) Pub. No.: US 2008/0208920 A1
(43) Pub. Date: Aug. 28, 2008

(54) Efficient detection of deleted objects against a stateless content directory service

(75) Inventors: Vlad Stirbu, Tampere (FI); Panu S. Markkanen, Oulu (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: NOKIA CORPORATION

(21) Appl. No.: 11/713,071

(22) Filed: Feb. 28, 2007

(51) Int. Cl. G06F 17/30

(52) U.S. Cl. 707/201

(57) ABSTRACT

The exemplary embodiments of this invention provides a method and apparatus that features synchronizing of data objects in a client device with a server in a system since a last synchronization between the client device and the server by obtaining a list of added or modified data objects since the last synchronization, updating a cached object list on the client device with the list of added or modified data objects, obtaining a sorted list of existing data objects from the server, and detecting deleted data objects based on the comparison between the updated cached object list and the sorted object list. In particular, the synchronizing may include a control point periodically synchronizing the data objects with a content directory service (CDS) in a Universal Plug and Play (UPnP) device architecture (UDA).

### BACKGROUND OF THE INVENTION

1. Field of Invention

The exemplary embodiments of this invention relate to a system such as Universal Plug and Play (UPnP) Device architecture (UDA); and more particularly, to synchronizing of data objects in a client device (e.g. control point (CP)) with a server (e.g. Content Directory Service (CDS)) in such a UDA.

2. Description of Related Art

UPnP™ technology defines an architecture for pervasive peer-to-peer network connectivity of intelligent appliances, wireless devices, and PCs of all form factors. It is designed to bring easy-to-use, flexible, standards-based connectivity to ad-hoc or unmanaged networks whether in the home, in a small business, public spaces, or attached to the Internet. UPnP technology provides a distributed, open networking architecture that leverages TCP/IP and the Web technologies to enable seamless proximity networking in addition to control and data transfer among networked devices.

The UPnP Device Architecture (UDA) is designed to support zero-configuration, “invisible” networking, and automatic discovery for a breadth of device categories from a wide range of vendors. This means a device can dynamically join a network, obtain an IP address, convey its capabilities, and learn about the presence and capabilities of other devices.

The UPnP AV defines how media devices (servers, renderers and control points) can communicate with each other for the distribution and consumption of content.

The UPnP CDS is a service that maintains metadata associated with media files in a directory like structure in such a UDA. The original CDS service version 1 does not keep track of changes in its structure making it difficult for a client device, such as a control point (CP) to track what happened since the last time it interacted with the service. In order to detect the changes, the CP has to browse the entire structure of the CDS and compare it with the cached metadata.

To correct this situation, a new mechanism for tracking changes was proposed in the UPnP AV Working Committee, e.g. see CR-81, which is hereby incorporated by reference in its entirety. The basic idea of this mechanism is to add to all objects in the CDS a new property upnp:objectUpdateID used to indicate when the object was last modified. The property helps a CP to identify which objects were added or modified since the last known SystemUpdateID of the CP associated with the corresponding CDS. However, the proposed mechanism falls short of providing a mechanism for tracking deleted objects as no information is stored in the CDS about them. To make things a little easier, the mechanism is able to hint to CPs in which containers are the deleted files so that the CP can browse the current content of the container and compare it with the cached metadata for that specific container. If some cached objects are not found in the current list from the CDS, then those are the deleted objects.

While the new mechanism proposed in CR-81 is an improvement, compared to the situation known in the prior art before, the algorithm for tracking the deleted objects is very expensive (i.e. time consuming) for the CP as the procedure involves sorting the list received from the CDS (having complexity O(nlogn)) and comparing it to the cached list (having the complexity O(n+m)). Overall, the algorithm complexity is O(nlogn).

In view of this, there is a need in the industry to solve the aforementioned problem in the art.

### SUMMARY OF THE INVENTION

The exemplary embodiments of this invention provide a method and apparatus that features synchronizing of data objects in a client device with a server in a system since a last synchronization between the client device and the server by obtaining a list of added or modified data objects since the last synchronization, updating a cached object list on the client device with the list of added or modified data objects, obtaining a sorted list of existing data objects from the server, and detecting deleted data objects based on the comparison between the updated cached object list and the sorted object list.

In particular, the synchronizing may include a control point periodically synchronizing the data objects with a content directory service (CDS) in a Universal Plug and Play (UPnP) device architecture (UDA).

The server should supports enhanced track changes, including the enhanced track changes for a content directory service (CDS), and also support the sorting of the data objects, including by way of example sorting of the data objects by an integer-based property such as a upnp:objectUpdateID tag. In effect, the list is sorted using a different tag than the one that is going to be compared, e.g. ObjectID vs. objectUpdateID. Moreover, the scope of the invention is also intended to include sorting with a non-integer datatype.

In operation, the client device requests the sorted object list from the server since the last update or synchronization. The server replies to the client device with a list of data objects that were added or modified since the last update or synchronization. The client device prepares the cached object list using the list of data objects that were added or modified since the last updated or synchronization so as to form a new cached object list. The client device compares a cached count of data objects in the cached object list with a count containing information about deleted data objects in the sorted object list in order to detect if some data objects were deleted.

The server may sort the-sorted object list according to a predetermined sort criteria, which may in some embodiments of the present invention contain information about a suitable integer-based property, such as the property+upnp:objectUpdateID. In this case, the client device compares the cached object list to the sorted object list using an integer-based property associated with each data object in respective object lists.

The client device may also request the sorting of the sorted object list by the server.

The data objects also form part of a container flagged as containing deleted objects.

The apparatus of the present invention may also take the form of a system such as a UDA described herein having such a CP and CDS cooperating consistent with that described herein, as well as other systems either now known or later developed in the future.

The apparatus of the present invention may also take the form of such a CP featuring one or more modules configured for synchronizing of such data objects in such a client device with such a server in such a system since such a last synchronization between the client device and the server by obtaining a list of added or modified data objects since the last synchronization, updating a cached object list on the client device with the list of added or modified data objects, obtaining a sorted list of existing data objects from the server, and detecting deleted data objects based on the comparison between the updated cached object list and the sorted object list.

The scope of the invention may also include a chipset for such a CP in such a UDA or other suitable system or architecture, as well as implementing the same in a computer program product with a program code, which program code is stored on a machine readable carrier, for carrying out the steps of the method according to the exemplary embodiments of this invention. The method may also feature implementing the step of the method via a computer program running in a processor, controller or other suitable module in such a CP.

In summary, the exemplary embodiments of this invention are concerned with synchronization of data objects in such a client device (e.g. Control Point (CP)) with such a UPnP server (e.g. Content Directory Service (CDS)). Moreover, the exemplary embodiments of this invention may also be applicable to unassisted synchronization of content via other technologies either now known or later developed in the future, consistent with that disclosed herein.

### BRIEF DESCRIPTION OF THE DRAWING

The drawing includes the following Figures, which are not necessarily drawn to scale:

FIG. 1 shows a system in the form of a UPnP Device Architecture according to some embodiments of the present invention.

FIG. 2 shows flow charts of the basic steps of according to some embodiments of the present invention.

FIG. 3 shows an example of a cached object list according to some embodiments of the present invention.

FIG. 4 shows an example of changes to the data objects in the server object list relative to the situation after the last synchronization in FIG. 3 according to some embodiments of the present invention.

FIG. 5 shows an example of a new objects list on the server in FIG. 1 according to some embodiments of the present invention.

FIG. 6 shows an example of a list of data objects added or modified since a last synchronization between the client device and the server in FIG. 1 according to some embodiments of the present invention.

FIG. 7 shows an example of a new cached object list updated in the client device shown in FIG. 1 according to some embodiments of the present invention.

FIG. 8 shows an example of lists to compare for detecting deleted objects in the client device shown in FIG. 1 according to some embodiments of the present invention.

FIG. 9 shows a client device shown in FIG. 1 in the form of a control point (CP) according to some embodiments of the present invention.

FIG. 10 shows a server in the form of a content directory service shown in FIG. 1 according to some embodiments of the present invention.

### DETAILED DESCRIPTION OF THE VARIOUS EMBODIMENTS

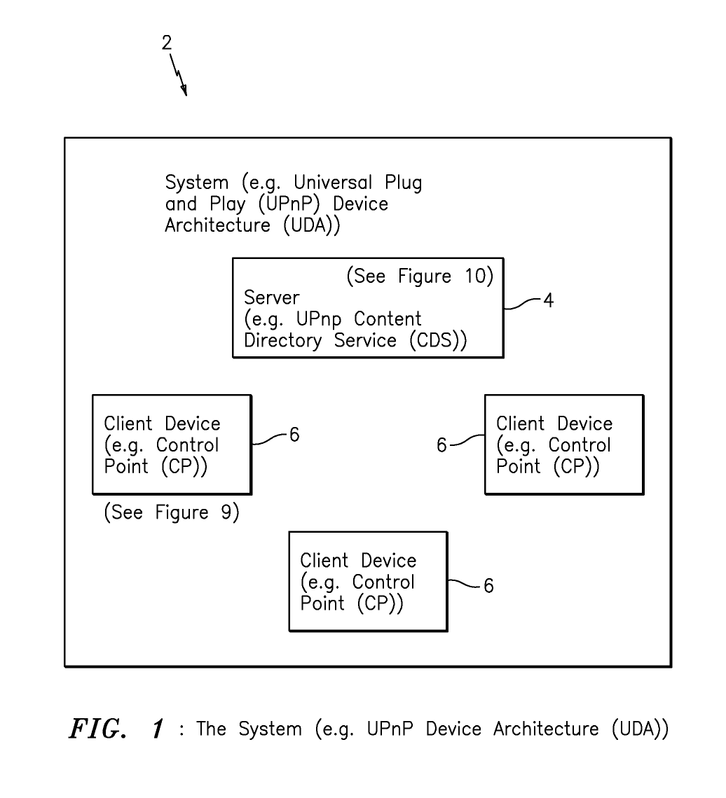

FIG. 1 shows, by way of example, a system, generally indicated as 2, according to the exemplary embodiments of this invention having a server 4 and one or more client devices 6. By way of example, and for the purpose of describing the exemplary embodiments of this invention, the system 2 is shown in the form of a UPnP Device Architecture (UDA); the server 4 is shown in the form of a UPnP Content Directory Service (CDS), and the one or more client devices 6 are shown the form of a control point (CP).

In operation, the exemplary embodiments of this invention features synchronizing of data objects in the client device 6 with the server 4 in the system 2 since a last synchronization between the client device and the server, by obtaining a list of added or modified data objects since the last synchronization, updating a cached object list on the client device with the list of added or modified data objects, obtaining a sorted list of existing data objects from the server, and detecting deleted data objects based on the comparison between the updated cached object list and the sorted object list (See FIG. 8).

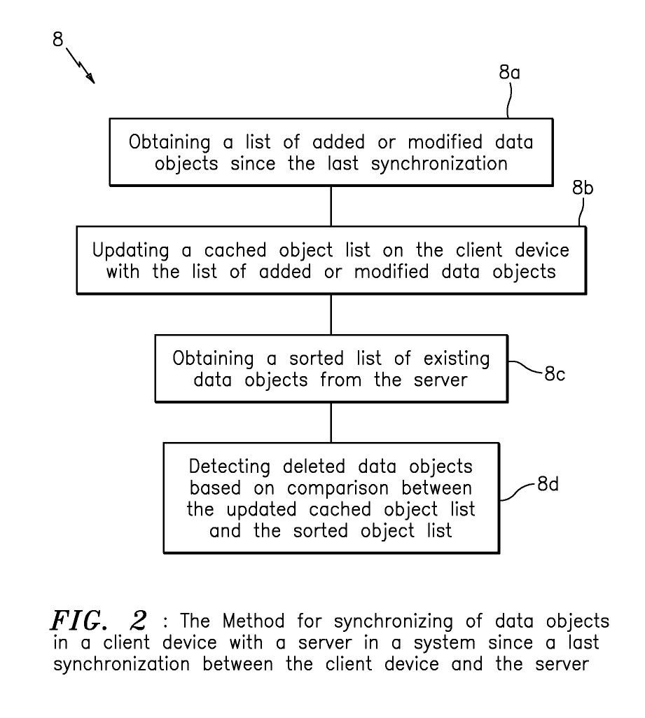

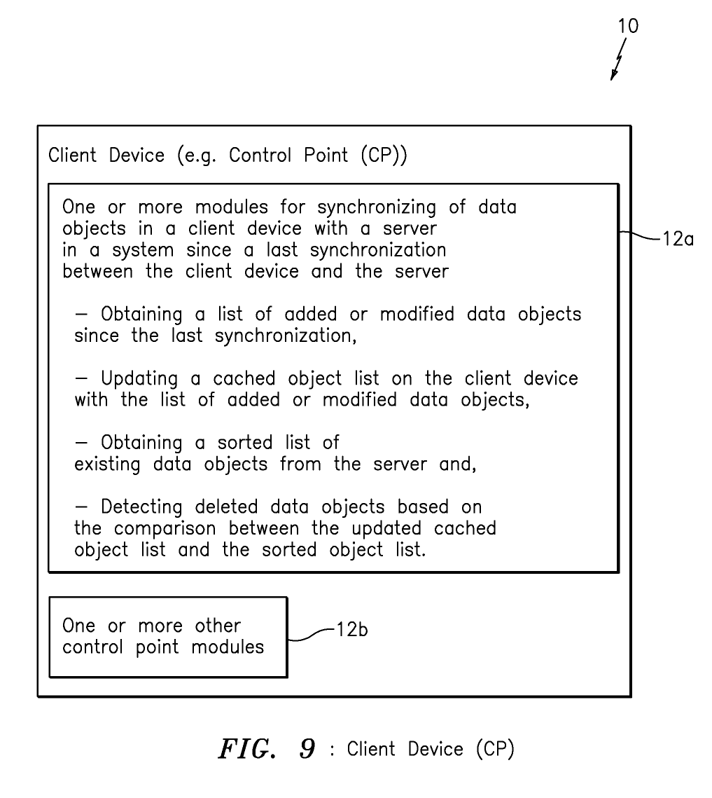

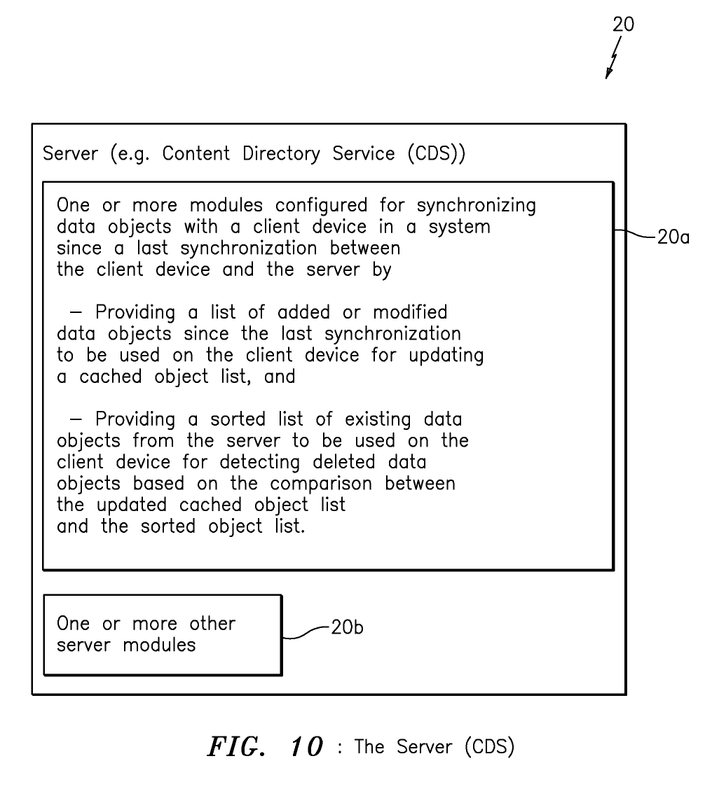

FIG. 2 shows a flowchart generally indicated as 8 having the basic steps 8a, 8b, 8c and 8d for implementing the inventive method according to some embodiments of the present invention. The scope of the invention is not intended to be limited to the order in which the steps in FIG. 2 are performed. These steps 8a, 8b, 8c and 8d may be implemented in one or more modules configured to do the same in such client devices like CP 6, as shown in more detail in FIG. 9 below.

It is understood that the aforementioned methods may include other steps known in the art that do not form part of the underlying invention, and thus are not described in detail herein.

### The Basic Implementation

The exemplary embodiments of this invention may be implemented, as follows:

### Environment Overview

In general, the exemplary embodiments of this invention can be applied in a network environment where there is at least one UPnP media server having support for the enhanced CDS track changes (e.g. CR-81). Additionally, the CDS needs to support the sorting for upnp:objectUpdateID tag, which in practice means that the value of the SortCapabilities state variable of the media server's CDS needs to be at least “upnp:objectUpdateID”.

Against such a media server, we have a control point that is periodically synchronising the metadata in its local cache.

### CDS Change Scenario

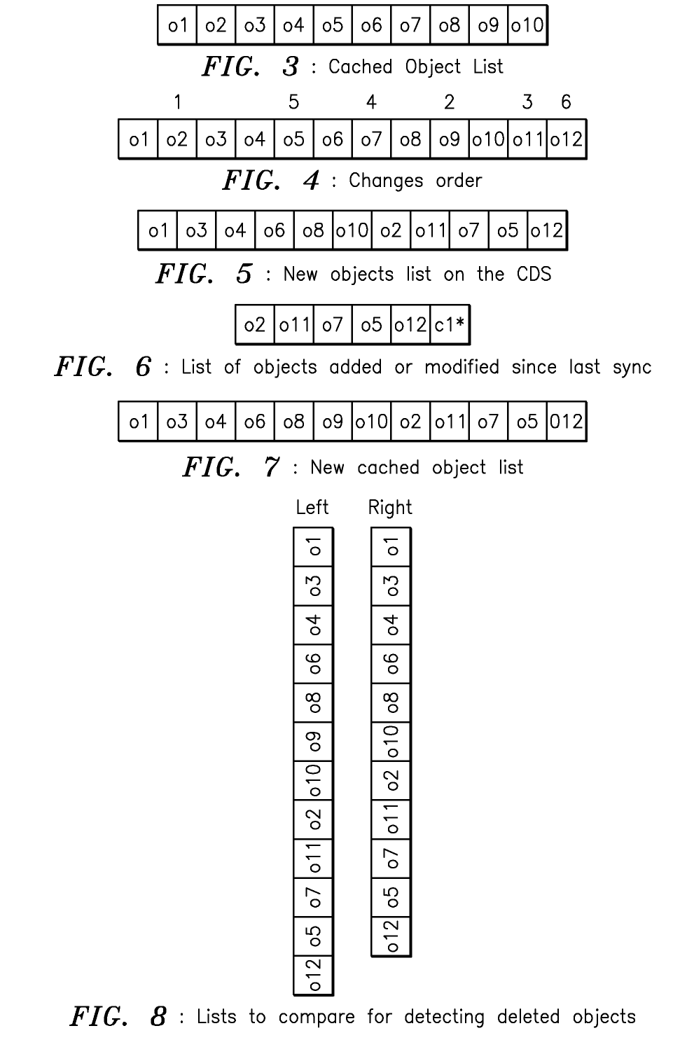

FIGS. 3-5 show the CDS change scenario, as follows:

After the last update, a container has, as an example, 10 child objects as shown in the cached object list in FIG. 3. (At the time of synchronization, the cached object list in the client device is the same as the information stored in the server.)

While the control point is offline, object o2 is updated, object o9 is deleted, object o11 is added, object o7 is updated, object o5 is updated and object o12 is added as shown in FIG. 4.

In the end, the container on the CDS will have the structure shown in the new objects list on the CDS in FIG. 5.

### Detecting the Changes in CDS

Step 1: Detecting Added and Modified Objects

The CP will request the list of changed items on the CDS since the last update (according to CR-81). The reply from CDS includes the list of items that were added or modified as shown in the list of objects added or modified since the last sync in FIG. 6.

The CP updates the local cache of the CDS with the objects added or modified since last sync as shown in the new cached object list in FIG. 7.

The CP detect that container c1 has totalDeletedChildCount property different than the local cached value, meaning that some objects in the container were deleted, and proceed to step 2 for detecting deleted objects.

Step 2: Detecting Deleted Objects

By comparing the totalDeletedChildCount retrieved from the CDS with the cached one the CP knows also how many objects were deleted.

The CP can fetch the list of existing objects in the container via, for example, the Browse( ) action. The CP can either request the server to sort the list based on a predetermined criteria contains information about an integer-based property (e.g. upnp:objectUpdateID), or the CP can perform the sort after it fetches the list. The result is as in FIG. 5. In order to detect the changed objects, the CP has to compare the returned list with the updated cached list resulted from Step 1, as shown by the lists to compare for detecting objects in FIG. 8.

The local cached object list is always longer than the list retrieved on the server as it contains the deleted objects. The lists needs to be sorted according to a predetermined sort criteria which contains information about a integer-based property, for example, “upnp:objectUpdateID”. Comparison is done according to following algorithm (a variation of “Left outer join”=, where Left is the cached list shown in FIG. 7 and Right is the existing list on the CDS shown in FIG. 5.

The algorithm is as follows:

```
i=1
j=1
deleted=0
while (j < or = RightListLength) and deleted < deletedObjects
    if Left(i).ObjectID = Right(j).ObjectID
        i+1
        j+1
    else
        Left(i) was deleted from CDS
        deleted+1
        i+1
endwhile.
```

In operation, both lists are sorted based on an integer-based property (e.g. objectUpdateID) but the comparison is between a string property (e.g. objectID, as shown in the aforementioned algorithm), which is not necessarily sorted. Normally, for the algorithm to work one would have to sort and compare the same property. However, according to the exemplary embodiments of this invention, the sort is done based on one property and the comparison was done based on another property. This technique is effective because when updating the lists at both the server and client side, the order of changes are maintained (i.e. if o2 is updated first, o2 will disappear from the original position but attached at the end of the list).

### Algorithm Complexity

If the lists are not sorted, the complexity of the algorithm involves sorting Left and Right lists and comparing them:

O(leftLenghtlog(leftLength))+
O(rightLengthlog(rightLength))+
O(leftLength).

The Left list structure is specific to the CP and, depending on the implementation, can be stored in such a way that it can be easily fetched already ordered after objectUpdateID. As the list is already in a native format (e.g. a database) and there is no need to obtain it from an XML structure specific to UPnP AV, we can “ignore” the complexity of sorting it (e.g. databases are highly optimised for sorting operations).

To eliminate the need to sort the Right list on the CP, it needs to be requested from the CDS already sorted. So, in the end in order to detect the deleted objects in a specific container on the CP side the complexity of the algorithm is:

O(n)

This is equivalent with the situation when the CDS is keeping an infinite log.

### Conclusion

To be able to perform the optimisation efficiently:

1) the CDS needs to be able to support sorting on integer-based property such as “upnp:objectUpdateID”,

2) the CP needs to be able to obtain from the CDS a list (sorted according to objectUpdateID) of current objects under a container flagged as containing deleted objects,

3) the CP needs to be able to prepare a cached list (also sorted according to objectUpdateID) updated with added and/or modified objects, and

4) the CP needs to be able to compare the ObjectIDs in the two lists to detect the deleted objects.

The prior art (CR-81) describes the method to detect the deleted objects that mentions only that the cached ObjectIDs needs to be compared with the ObjectsIDs from the server. No sorting involved.

Note: ObjectID type is string (max 256 bytes long according the DLNAv1.5) while objectUpdateID is integer. Therefore, it is much more efficient to sort integers than stings.

From the CP perspective, the overall complexity of the algorithm is O(n) that is similar to the situation when the CDS is providing a deleted objects log. Sort operations required involve lists of integers, which are less computational intensive than sorting strings. Simpler CDS implementations, no need to implement log and log management functions.

### Device Implementation

FIG. 9 shows, by way of example, one such client device 6 (see FIG. 1) in the form of such a control point (CP) generally indicated as 10 according to some embodiments of the present invention for the UDA 2 or other suitable system such as that shown in FIG. 1. The CP 10 has modules 12a and 12b, including one or more modules 12a configured for synchronizing of data objects in a client device with a server in a system since a last synchronization between the client device and the server, by obtaining a list of added or modified data objects, updating a cached object list on the client device with the list of added or modified data objects, obtaining a sorted list of existing data objects from the server, and detecting deleted data objects based on the comparison between the updated cached object list and the sorted object list. Consistent with that described above, the CP 12 may also have one or more other control point modules 12b that do not necessarily form part of the underlying invention and are not described in detail herein.

FIG. 10 shows, by way of example, one such server 4 in FIG. 1 in the form of a content directory service (CDS) generally indicated as 20 according to some embodiments of the present invention for the UDA 2 or other suitable system such as that shown in FIG. 1. The CDS 20 has modules 22a and 22b, including one or more modules 22a configured for synchronizing of data objects in a client device with a server in a system since a last synchronization between the client device and the server by providing a list of added or modified data objects since the last synchronization to be used on the client device for updating a cached object list, and providing a sorted list of existing data objects from the server to be used on the client device for detecting deleted data objects based on the comparison between the updated cached object list and the sorted object list. Consistent with that described above, the server 22 may also have one or more other server modules 22b that do not necessarily form part of the underlying invention and are not described in detail herein.

### Implementation of the Functionality of Modules 12a, 22b

By way of example, and consistent with that described herein, the functionality of the one or more modules 12a and/or 22a may be implemented using hardware, software, firmware, or a combination thereof, although the scope of the invention is not intended to be limited to any particular embodiment thereof. In a typical software implementation, the modules 12a and/or 22a would be one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology now known or later developed in the future. Moreover, the scope of the invention is intended to include the modules 12a and/or 22a respectively being stand alone modules, as shown, or in the combination with other circuitry for implementing another module. Moreover, the real-time part may be implemented in hardware, while non real-time part may be done in software.

The one or more other modules 12b and/or 22b may also include other modules, circuits, devices that do not form part of the underlying invention per se. The functionality of the other modules, circuits, device that do not form part of the underlying invention are known in the art and are not described in detail herein.

### The Chipset Implementation

The exemplary embodiments of this invention may also include one or more of the modules 12a and 12b and/or 22a and 22b in FIGS. 9 and 10 forming part of a chipset. For example, a CP chipset for such a CP in such a UDA 2 or other suitable network may include a number of integrated circuits designed to perform one or more related functions. For example, one chipset may provide the basic functions of a modem while another provides the CPU functions for a computer. Newer chipsets generally include functions provided by two or more older chipsets. In some cases, older chipsets that required two or more physical chips can be replaced with a chipset on one chip. The term “chipset” is also intended to include the core functionality of a motherboard in such a node, point, terminal or device.

### Scope of the Invention

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

1. A method comprising:
synchronizing of data objects in a client device with a server in a system since a last synchronization between the client device and the server by
obtaining a list of added or modified data objects since the last synchronization;
updating a cached object list on the client device with the list of added or modified data objects;
obtaining a list of existing data objects from the server; and
detecting deleted data objects based on the comparison between the updated cached object list and the sorted object list.

2. A method according to claim 1, wherein the server supports enhanced track changes, including the enhanced track changes for a content directory service (CDS).

3. A method according to claim 1, wherein the client device requests that the server provide a sorted list of existing data objects.

4. A method according to claim 1, wherein the client device compares a cached count of data objects in the cached object list with a count containing information about deleted data objects in the sorted object list in order to detect if some data objects were deleted.

5. A method according to claim 1, wherein the server sorts the sorted object list according to a predetermined sort criteria.

6. A method according to claim 5, wherein the predetermined sort criteria contains information about an integer-based property.

7. A method according to claim 3, wherein the client device compares the cached object list to the sorted object list using an string-based property associated with each data object in respective object lists.

8. A method according to claim 1, wherein the client device performs a sort on the list of existing data objects from the server so as to provide a sorted object list.

9. A method according to claim 8, wherein the client device compares the cached object list to the sorted object list using an string-based property associated with each data object in respective object lists.

10. A method according to claim 1, wherein the data objects form part of a container flagged as containing deleted objects.

11. A system comprising:
a client device having
one or more modules configured for synchronizing of data objects in the client device with a server in the system since a last synchronization between the client device and the server by
obtaining a list of added or modified data objects since the last synchronization;
updating a cached object list on the client device with the list of added or modified data objects;
obtaining a list of existing data objects from the server; and
detecting deleted data objects based on the comparison between the updated cached object list and the sorted object list.

12. A system according to claim 11, wherein the server supports enhanced track changes, including the enhanced track changes for a content directory service (CDS).

13. A system according to claim 11, wherein the client device requests that the server provide a sorted list of existing data objects.

14. A system according to claim 11, wherein the client device compares a cached count of data objects in the cached object list with a count containing information about deleted data objects in the sorted object list in order to detect if some data objects were deleted.

15. A system according to claim 11, wherein the server sorts the sorted object list according to a predetermined sort criteria.

16. A system according to claim 15, wherein the predetermined sort criteria contains information about an integer-based property.

17. A system according to claim 11, wherein the client device compares the cached object list to the sorted list using a string-based property associated with each data object in respective object lists.

18. A system according to claim 11, wherein the client device performs a sort on the list of existing data objects from the server so as to provide a sorted object list.

19. A system according to claim 18, wherein the client device compares the cached object list to the sorted object list using an string-based property associated with each data object in respective object lists.

20. A system according to claim 11, wherein the data objects form part of a container flagged as containing deleted objects.

21. A client device comprising:
one or more modules configured for synchronizing of data objects in the client device with a server in a system since a last synchronization between the client device and the server by
obtaining a list of added or modified data objects since the last synchronization;
updating a cached object list on the client device with the list of added or modified data objects;
obtaining a list of existing data objects from the server; and
detecting deleted data objects based on the comparison between the updated cached object list and the sorted object list.

22. A client device according to claim 21, wherein the server supports enhanced track changes, including the enhanced track changes for a content directory service (CDS).

23. A client device according to claim 21, wherein the client device requests that the server provide a sorted list of existing data objects.

24. A client device according to claim 21, wherein the client device compares a cached count of data objects in the cached object list with a count containing information about deleted data objects in the sorted object list in order to detect if some data objects were deleted.

25. A client device according to claim 21, wherein the sorted object list is sorted according to a predetermined sort criteria.

26. A client device according to claim 25, wherein the predetermined sort criteria contains information about an integer-based property.

27. A client device according to claim 21, wherein the client device compares the cached object list to the sorted object list using a string-based property associated with each data object in respective object lists.

28. A client device according to claim 21, wherein the client device performs a sort on the list of existing data objects from the server so as to provide a sorted object list.

29. A client device according to claim 26, wherein the client device compares the cached object list to the sorted object list using an string-based property associated with each data object in respective object lists.

30. A client device according to claim 21, wherein the data objects form part of a container flagged as containing deleted objects.

31. A server comprising:
one or more modules configured for synchronizing data objects with a client device in a system since a last synchronization between the client device and the server by
providing a list of added or modified data objects since the last synchronization to be used on the client device for updating a cached object list; and
providing a list of existing data objects from the server to be used on the client device for detecting deleted data objects based on the comparison between the updated cached object list and the sorted object list.

32. A server according to claim 31, wherein the server supports enhanced track changes, including the enhanced track changes for a content directory service (CDS).

33. A server according to claim 31, wherein the server responds to a request from the client device and provides a sorted list of existing data objects.

34. A server according to claim 33, wherein the server also provides a count containing information about deleted data objects in the sorted object list for the client device to compare with a cached count of data objects in the cached object list in order to detect if some data objects were deleted.

35. A server according to claim 33, wherein the server sorts the sorted object list according to a predetermined sort criteria.

36. A server according to claim 35, wherein the predetermined sort criteria contains information about an integer-based property.

37. A server according to claim 31, wherein the data objects form part of a container flagged by the server as containing deleted objects.

38. A computer program product embodied in a computer-readable medium for synchronizing data objects in a client device with a server in a system since a last synchronization between the client device and the server, comprising: a computer code for obtaining a list of added or modified dais objects since the last synchronization; a computer code for updating a cached object list on the client device with the list of added or modified data objects; a computer code for obtaining a list of existing data objects from the server; and a computer code for detecting deleted data objects based on the comparison between the updated cached object list and the sorted object list.

39. Apparatus comprising:
one or more means for synchronizing of data objects in a client device with a server in a system since a last synchronization between the client device and the server by
obtaining a list of added or modified data objects since the last synchronization;
updating a cached object list on the client device with the list of added or modified data objects;
obtaining a sorted list of existing data objects from the server; and
detecting deleted data objects based on the comparison between the updated cached object list and the sorted object list.

40. A chipset implementation comprising:
one or more chipsets configured for synchronizing of data objects in a client device with a server in a system since a last synchronization between the client device and the server by
obtaining a list of added or modified data objects since the last synchronization;
updating a cached object list on the client device with the list of added or modified data objects;
obtaining a sorted list of existing data objects from the server; and
detecting deleted data objects based on the comparison between the updated cached object list and the sorted object list.
